(19) United States
(12) Patent Application Publication
(10) Pub. No.: US 2003/0070883 A1
(43) Pub. Date: Apr. 17, 2003

(54) Elevator selector

(76) Inventors: Michael M. Foster, Southaven, MS (US); Dennis Farrar, Memphis, TN (US)

Correspondence Address: WHITE & CASE LLP, PATENT DEPARTMENT, 1155 AVENUE OF THE AMERICAS, NEW YORK, NY, 10036, US

(21) Appl. No.: 10/226,996

(22) Filed: Aug. 22, 2002

Related U.S. Application Data
(60) Provisional application No. 60/314,593, filed on Aug. 23, 2001.

(51) Int. Cl. B66B 1/34

(52) U.S. Cl. 187/394

(57) ABSTRACT

The present invention relates to an improved elevator selector system. One embodiment incorporates all of the operational and A17 code required car position sensing functions into a single car mounted enclosure, without any external mechanical roller switches, by incorporating directional limits, normal terminal slow down and emergency terminal speed limiting functions into a tape selector. All operational and sensing functions may be implemented using a standard 3-inch wide tape by disposing of magnetic signalers on the opposite side of the tape from the side used for leveling and floor identification. An alignment tool facilitates placement of magnets. Tape guides permit the selector to run smoothly along the tape. Optical rather than magnetic sensors may be used for quadrature hole counting to detect relative speed and location without interfering with other magnetic functions. All selector components may be tethered to the selector enclosure to prevent accidental loss down the hoistway. Structural foam and heavy internal gussets may be used for the selector enclosure. Alignment pins on the selector enclosure facilitate component installation. Stress distributing nut plates create a strong interface between the selector enclosure and steel mounting bracket.

This application claims the benefit of U.S. Provisional Application No. 60/314,593, filed Aug. 23, 2001.

### FIELD OF THE INVENTION

The present invention relates to elevator systems. More particularly, the invention relates to an improved elevator selector system.

### BACKGROUND OF THE INVENTION

Elevator selectors are generally devices used for determining car position. Elevator tape selectors have been in use for several years. However, tape selectors have traditionally not incorporated the terminal back-up systems of directional limits, normal terminal slow-down devices, and emergency terminal speed limiting. Rather, these functions are traditionally performed with mechanical roller switches in the hoistway. Mechanical roller switches are expensive and their assembly and adjustment is labor intensive. Traditionally, to increase the number of functions available on a tape selector, additional tracks are added to the tape, making the tape wider.

Tape selector housings generally are comprised of fabricated enclosures utilizing many discrete parts, including screws, fasteners, washers, lock washers, plates and circuit boards. Assembly of the large plurality of parts is time-consuming and involves many steps, including shearing, punching, welding, and inserting press nuts. In addition, maintenance of such a selector generally involves the risk of dropping one or more of these parts down the hoistway, thus posing a safety risk and a cost in time and material. Selectors composed of a large plurality of parts also pose a difficulty in proper assembly of the parts during installation and maintenance since the mounting locations are typically in dark, confined and hard-to-reach locations on the car top.

A typical tape selector using strip magnets often presents potential installation problems with respect to the proper placement and polarity of the magnets. Some selectors are relatively tall in size because of a necessity to isolate certain magnetic functions, like hole counting to determine relative location and speed, from other functions, like floor detection and leveling.

### SUMMARY OF THE INVENTION

The present invention recognizes the above limitations of prior art elevator selectors and reduces or eliminates these problems. Although the present invention will be described as part of an elevator system, it shall be understood that the improved selector may be employed in other systems requiring position information about a moving cab, carriage, carrier, moving part, etc. In particular, this invention may be applied to other types of elevators or people movers than the type(s) or embodiments described here for purpose of illustration and description of the invention.

One embodiment of the present invention is an improved tape selector system which incorporates all of the operational and A17 code required car position sensing functions into a single car mounted enclosure, called a selector, without any external mechanical roller switches, by incorporating directional limits, normal terminal slow down and emergency terminal speed limiting functions into a tape selector. The active portions of the functions have been incorporated into a single car mounted enclosure by adding sensors to detect the following signals: Directional Limit Bottom (DLB), Directional Limit Top (DLT), Normal Terminal Slow-down Bottom (NTSB), Normal Terminal Slow-down Top (NTST), emergency Terminal Speed Limiting one (TSL1), emergency Terminal Speed Limiting two (TSL2). The passive portion of the functions has been added to two tracks on the previously unused side of a standard 3-inch wide tape mounted in the hoist-way. By incorporating all of the functions into only two tracks on the previously unused side of the tape, the functions may be added without increasing the size of the tape.

The additional functions in the improved selector system are implemented with a plurality of appropriately placed north and south polarized magnets distributed along the tape, a plurality of sensors within the selector for detecting the magnets and dynamic real-time decoding. The sensors may be hall effect sensors, and they may be positioned on the back of the circuit board and placed in a hole to improve alignment. The magnets associated with the DLB and DLT functions are arranged in the first track on the previously unused side of the tape, and those associated with the NTSB, NTST, TSL1, and TSL2 are arranged in the second track. Although the NTST, TSL1and TSL2 functions all operate in substantially the same vertical locations and using the same track, NTST functions independently from TSL1and TSL2, as required by the A17 code. An alignment tool facilitates placement of the magnets along the tape.

Tape guides may be installed between the tape and the main circuit board and auxiliary circuit board to hold the tape and permit the selector to run smoothly along the tape.

A further improvement involves use of optical rather than magnetic sensors and signals for quadrature hole counting to detect relative speed and location. Optical sensors may be imbedded within the same area without interfering with other magnetic functions. Sequentially-pulsed LED pairs may be used for quadrature hole-count detection to prevent cross talk between adjacent sensors by only having one sensor on at one time. A differential circuit with pass filtration used on the infrared detection circuit to block ambient light and improve detection provides superior performance over the circuits recommended in the prior art for the type of infrared detectors used.

All selector components, except the tape guides, may be made captive in or tethered to the selector enclosure, thereby improving ease of installation and maintenance by preventing accidental loss down the hoistway. The specific enclosure designed for the selector utilizes structural foam and heavy internal gussets for rigidity to provide lower cost, fewer components, improved performance and consistency over fabricated metal boxes.

The selector enclosure has alignment pins to facilitate and guide component installation by tactile rather than visual means. Instead of threaded press nut inserts, the selector enclosure has molded cavities which accommodate stress distributing nut plates, which create a stronger interface between the plastic enclosure and steel mounting bracket used to mount the selector on the elevator car with standard bolts. The nut plates are removable and reversible permitting left or right mounting requiring only 2 nut plates instead of 4 nut plates.

Those skilled in the art will realize that numerous modifications and variations of the present invention are possible in light of the above teachings and embodiments. Therefore, the invention should not be construed as limited to any of the foregoing embodiments, but instead should be viewed within the scope of the appended claims.

### BRIEF DESCRIPTION OF THE FIGURES

FIG. 1 is a front, schematic view of an elevator system in accordance with an embodiment of the invention;

FIG. 2 is a perspective view of a selector housing and tape in accordance with an embodiment of the invention;

FIG. 3 is a front view of a portion of the elevator guide rail and selector tape together with the selector housing mounted on the car;

FIG. 4a is a schematic of how the optical hole detection works in accordance with an embodiment of the invention;

FIG. 4b illustrates quadrature output from the tape hole detection and the phase relationship between the phase “A” and phase “B”;

FIG. 5a is a schematic of how the optical hole detection works in accordance with an alternative embodiment of the invention in which additional components and logic produce a doubling of the resolution of the hole detection function;

FIG. 5b illustrates quadrature output from an alternative embodiment of the tape hole detection and the derivation of phase “A” and phase “B” from the “XOR” of Photodiodes A and B, and Photodiodes C and D, respectively;

FIG. 6 is a schematic of how the floor identification function is performed;

FIG. 7 is a schematic of how the leveling and door zone functions are performed;

FIG. 8 is a schematic of how the directional limit detection functions are performed in accordance with an embodiment of the invention;

FIG. 9 is a schematic of how the terminal slow-down and speed limiting detection functions are performed in accordance with an embodiment of the invention;

FIG. 10 is a schematic showing the car closer to the terminal landing than in FIG. 9 in accordance with an embodiment of the invention;

FIG. 11 is a schematic showing the car closer to the terminal landing than in FIG. 10 in accordance with an embodiment of the invention;

FIG. 12 is schematic showing the car closer to the terminal landing than in FIG. 11 in accordance with an embodiment of the invention;

FIGS. 13 and 14 are front and side views of a selector tape system “T” in accordance with an embodiment of the invention;

FIG. 15 is a top plan view of the tape showing the magnet placement in accordance with an embodiment of the invention;

FIG. 16 is a front view of a section of the selector tape showing an arrangement of magnets for indicating floor position, leveling and door zone;

FIG. 17 is a rear view of a section of the selector tape showing an arrangement of magnets for indication of directional limits and terminal slow-downs according to the invention;

FIG. 18 is a schematic of the photodiode detection circuit in accordance with an embodiment of the invention;

FIG. 19 is an exploded perspective view from the opposite side of FIG. 2 in accordance with an embodiment of the invention;

FIG. 20 shows a perspective view of the relationship between the two printed circuit boards and the tape in accordance with an embodiment of the invention;

FIG. 21 shows a front, top and side view of the selector housing and view of one of the alignment pins in accordance with an embodiment of the invention;

FIG. 22 shows the selector housing in perspective and one of the internal gussets in accordance with an embodiment of the invention;

FIG. 23 shows a front view of one corner of the enclosure housing with one of the corner gussets in accordance with an embodiment of the invention;

FIG. 24 shows a front view of one of the cavities used to hold the nut plates according to an embodiment of the invention;

FIG. 25 shows one embodiment of the magnet alignment tool;

FIG. 26 shows a front view of the alignment tool of FIG. 25; and,

FIG. 27 shows an end view of the alignment tool of FIG. 25.

### DETAILED DESCRIPTION OF THE INVENTION

The features of the invention will now be described in reference to the embodiments described in the Figures. The embodiments described in this invention are intended to be merely exemplary and not limiting in any way. Numerous variations and modifications of the present invention will be readily apparent to those skilled in the art. All such variations and modifications are intended to be within the scope of the present invention as defined in the attached claims.

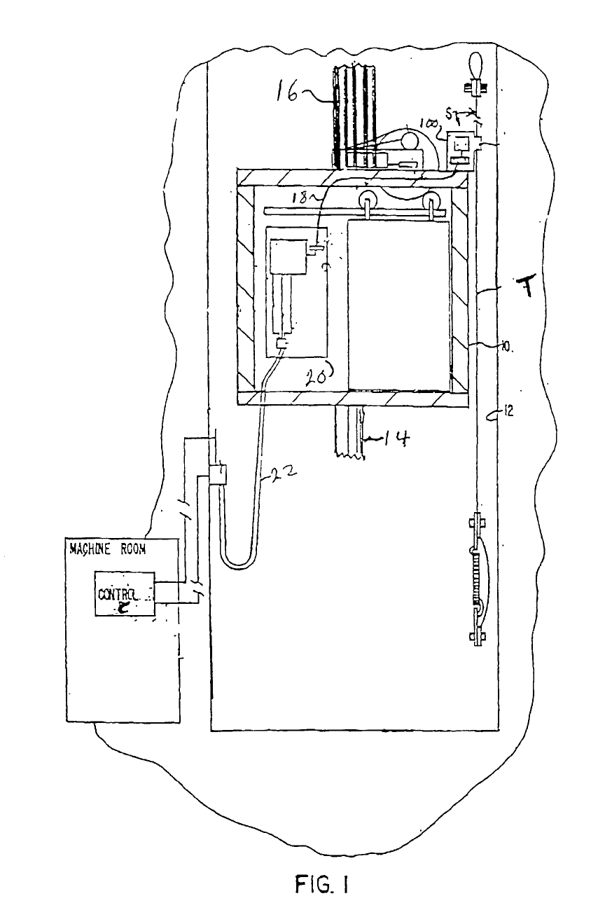

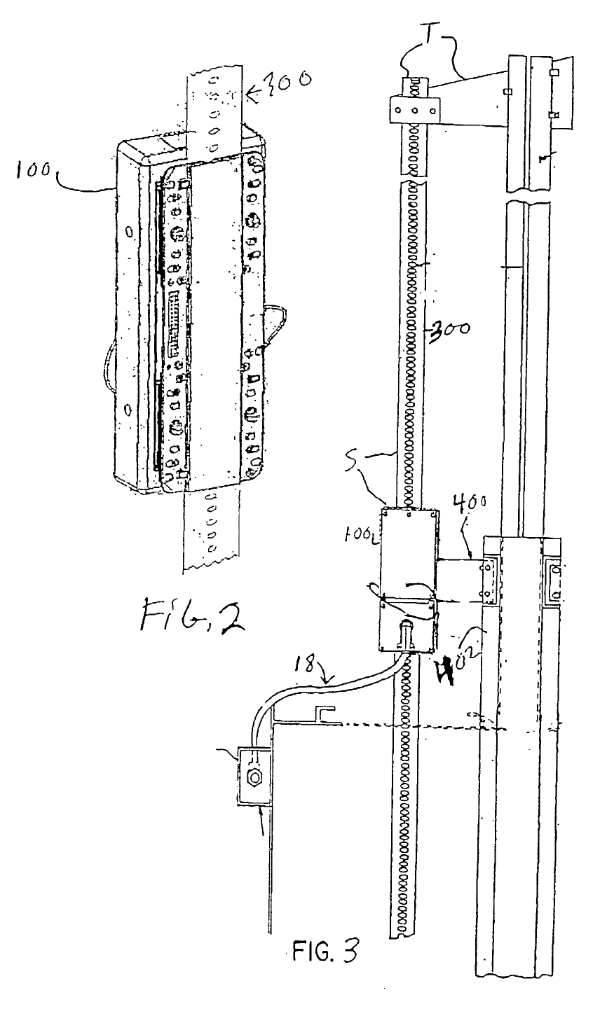

FIG. 1 shows an elevator system that includes a car 10 vertically displaceable in a hoistway 12 between landings. The car 10 is raised and lowered by either a hydraulic jack 14 connected to a pump unit controlled by an elevator control system “C”, or a set of ropes 16 connected to a traction drive system controlled by an elevator control system “C”. The elevator system in FIG. 1 also includes a selector system “S”, which includes a enclosure body member 100 mounted on the car and a tape system “T” mounted in the hoistway and a harness 18 supplying electrical power to and signals from the main printed circuit board within the enclosure body member 100, also shown in FIGS. 2 and 3. The other end of the harness 18 is connected to the control system via car swing return 20 and traveling cable 22.

The selector system “S” provides various signals that are derived from the tape system “T” to the controller. In some embodiments of this system, the controller “C” may be in the machine room and a serial device in the car operating panel 20 receives the signals from the selector system “S” and sends them serially to the controller.

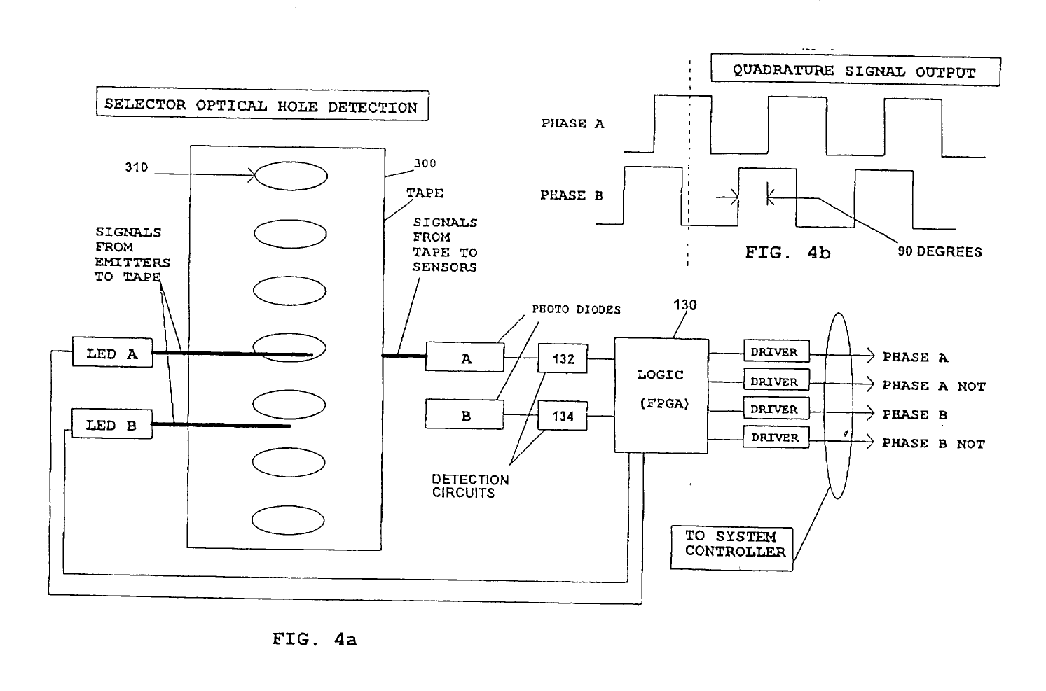

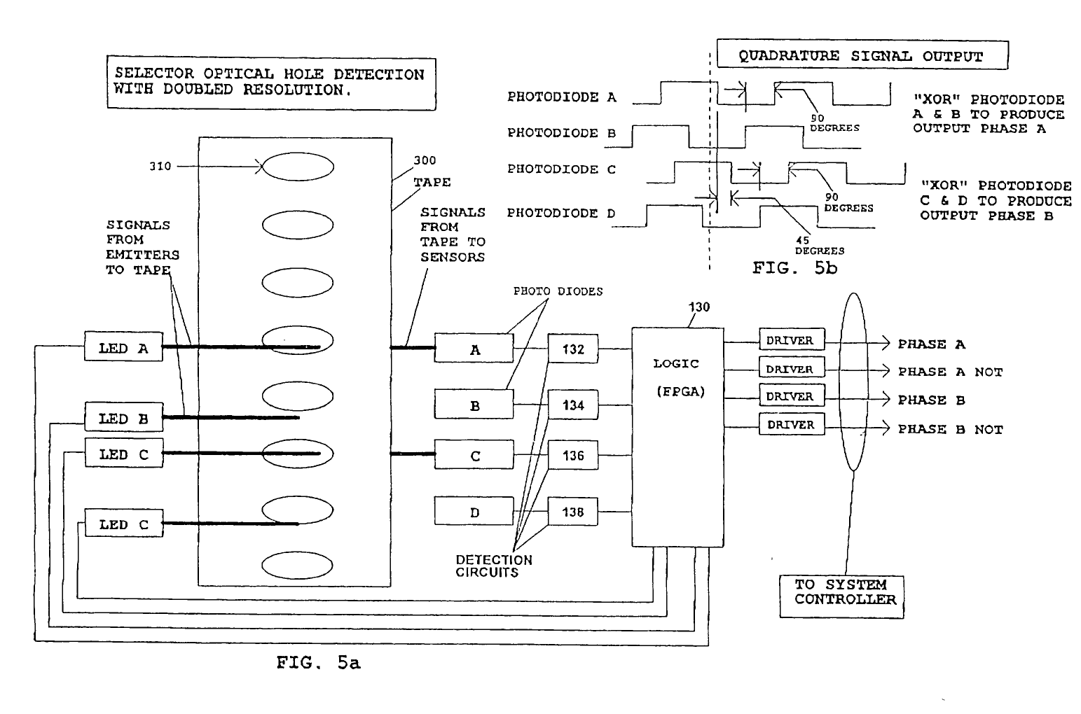

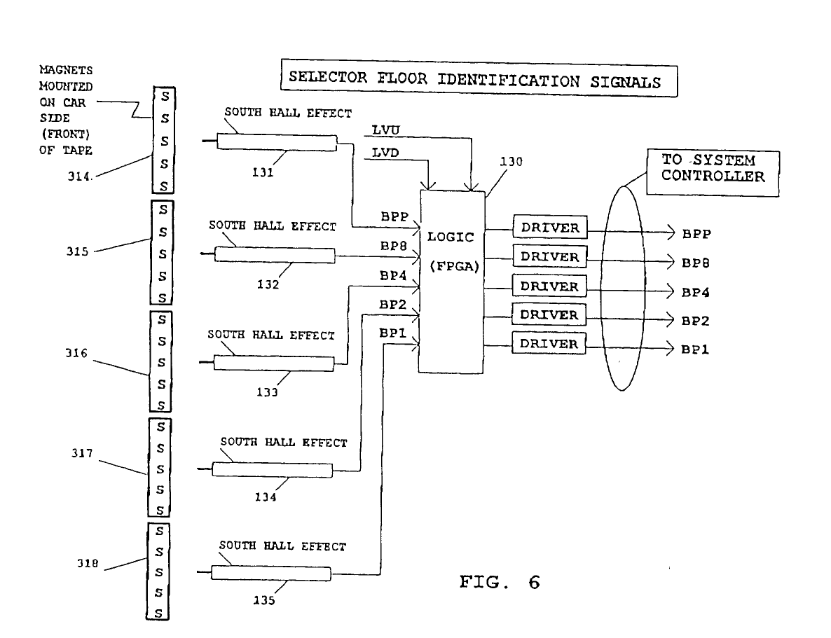

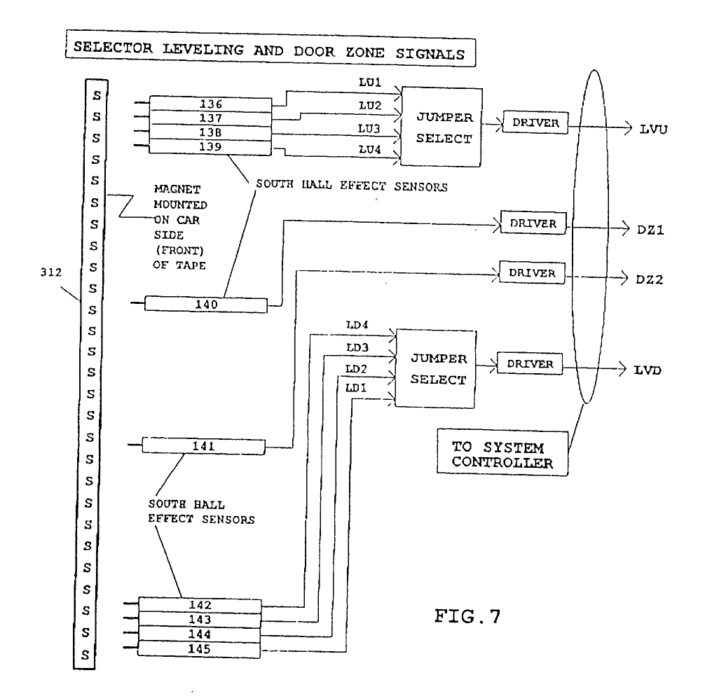

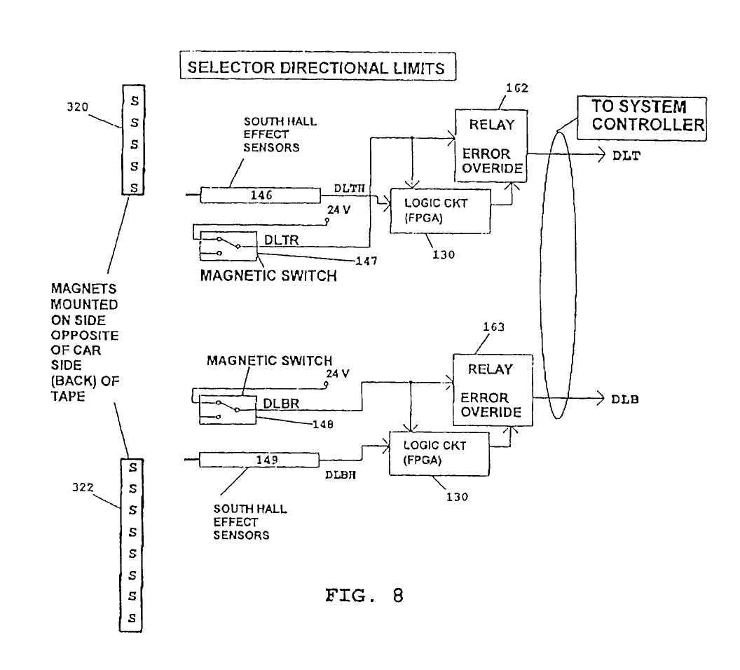

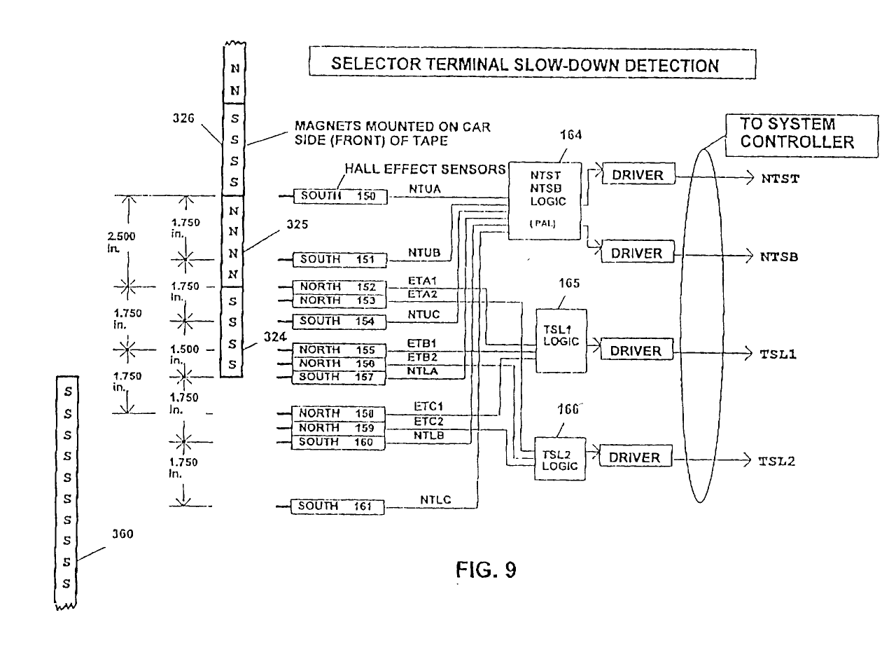

FIGS. 4, 5, 6, 7, 8, and 9 show schematically the typical relevant signals derived from the tape system and supplied to the controller. In FIG. 4a are shown quadrature hole detection signal A, (phase A), quadrature hole detection signal opposite state of A, (phase A NOT), quadrature hole detection signal B, (phase B), quadrature hole detection opposite state of B, (phase B NOT). FIG. 4b shows the relationships of the quadrature outputs of phase A and phase B which are approximately 90 electrical degrees apart from each other. FIGS. 5a and 5b show an alternative embodiment of FIGS. 4a and 4b. In FIG. 6, the floor identification signals are shown, BPP, BP8, BP4, BP2, and BP1. FIG. 7 shows leveling and door zone signals, Level Up, LVU, Level Down, LVD, Door Zone 1, DZ1, Door Zone 2, DZ2. FIG. 8 shows the directional limit signals: Directional Limit Top (DLT) and Directional Limit Bottom (DLB). FIG. 9 shows the terminal slow-down signals, Normal Terminal Slow-down Top (NTST), Normal Terminal Slow-down Bottom (NTSB), emergency Terminal Speed Limiting 1 (TSL1), emergency Terminal Speed Limiting 2 (TSL2).

In certain embodiments, where the horizontal movement of the car 10 in relation to the hoistway 12 is sufficiently constrained and where continuous car position is not required between floors, hole counting, as shown in FIGS. 4 and 5, may be eliminated and the tape system “T” may be replaced with plates used to hold the magnets at or near each floor, with the enclosure body member modified accordingly.

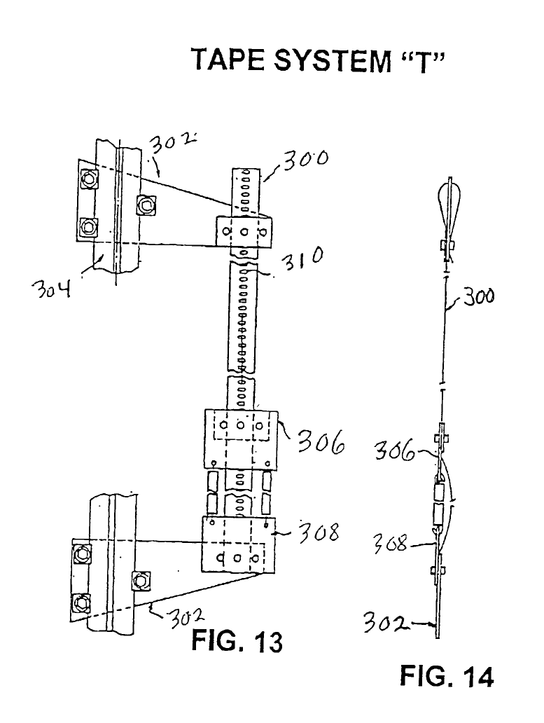

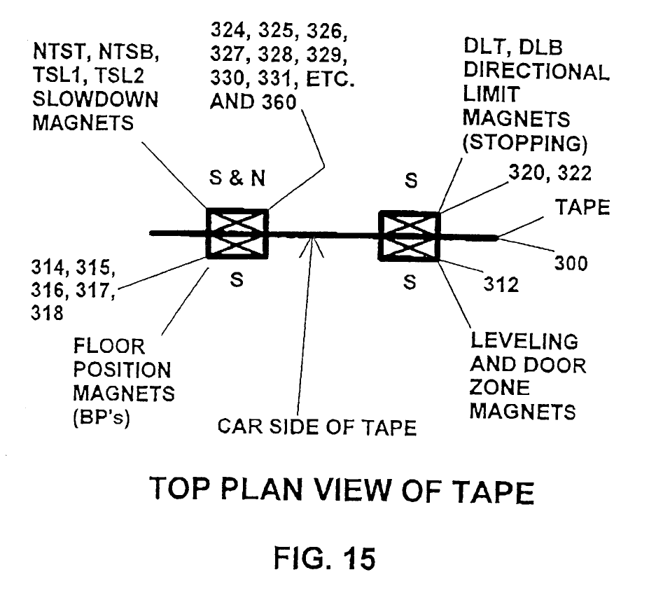

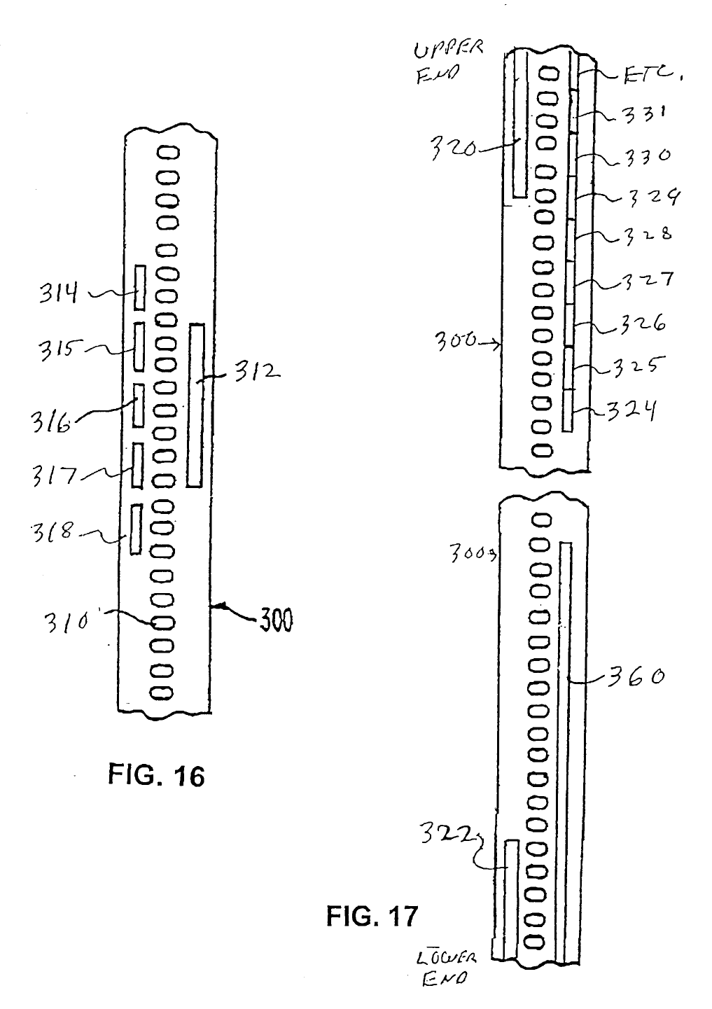

FIGS. 13, 14, 15, 16, and 17 show the tape system “T”. In the particular embodiments shown in FIGS. 13 and 14, the top of tape 300 is attached to bracket 302 which is attached to elevator rail 304. The bottom of tape 300 is attached to bracket 306 which is spring connected to bracket 308, which is in turn attached to a bracket 302 attached to the elevator rail 304. The tape 300 is a 3-inch wide tempered steel tape. FIG. 15 shows a plan sectional view of the steel tape 300 with the magnets. FIG. 16 shows the car side view of the tape and FIG. 17 shows the opposite side. The floor identification magnets 314 through 318 are shown in relation to the leveling magnet 312 as it would be for a single floor with a code that required all of the identification magnets. Different combinations of magnets can be used for different floors.

In an embodiment of the present invention, the side of the tape opposite the car side, shown in FIG. 17, is used to provide directional limit and normal terminal slow-down and emergency terminal speed limiting functions. The directional limit magnets of 320 at the top and 322 at the bottom generate DLT and DLB signals to operate the directional limit sensors in the selector. These are placed to operate the DLT sensor 1 inch above the floor and the DLB sensor 1 inch below the floor.

The bottom slow-down magnet 360 is set to operate the appropriate sensors at a distance from the bottom landing dictated by the car speed. The top slow-down magnets 324 through 331, with additional magnets represented by “etc.” and shown at the top of FIG. 17, are set to operate the appropriate sensors at a distance from the top landing dictated by the car speed. The polarity of magnet 324 is south. The polarity of magnet 325 is north. The polarity of magnet 326 is south. This alternating pattern is continued up the tape until the directional magnet 320 is reached or exceeded. All other magnets on the tape are south pole magnets. The length of magnet 360 extends from the required starting point dictated by the car speed down the tape until the directional limit magnet 322 is reached or exceeded. The length of the directional limit magnets 320 and 322 is sufficient to prevent the car from traveling up past 320 or down past 322. These distances and magnet locations are where the appropriate selector sensor position is located vertically, when the car is in the referenced location. This feature can also be seen in FIGS. 4 through 9.

### SELECTOR OPERATION

Selector Mounting

As shown in FIG. 3, the enclosure body member 100 is attached to the car via bracket 400 and stile 402. Stile 402 is part of the sling that holds and is attached to the car 10. Thus, as the elevator car 10 in FIG. 1 moves up and down the hoistway, so does the enclosure body member 100. The enclosure body member 100 and its associated sensors surround the tape 100 such that there are sensors on both sides of the tape 100. Tape guides 104 hold the tape in place to maintain running clearances between the TSM board 101 and the auxiliary assembly 102. See FIGS. 2, 19 and 20.

Optical Tape Hole Counting

In FIG. 4a, the holes in the tape 300 are shown interrupting the optical infrared signals from LED “A” and LED “B” to photodiodes “A” and “B”. As the car moves vertically up or down, the holes alternately interrupt, or not, the signals. The phase “A” LED and photodiode “A” are spaced vertically from the “B” LED and photodiode “B” such that the signals as shown in FIG. 4b are in quadrature or about 90 electrical degrees apart. These quadrature signals allow the controller “C” to determine the relative position of the car by counting the holes and determine the direction of movement by the quadrature nature of the signals. The logic 130 shown in FIG. 4a controls the output of the LEDs “A” and “B” and amplifies, filters, compares and decodes the signals from the photodiodes “A” and “B”. The logic, in this case a field programmable gate array (FPGA), pulses the phase “A” diode with a high current to achieve a high infra red light output, but for a short duration. A pulse of 5 microseconds, used in this case, prevents overheating of the diode.

The logic 130, having turned on the LED “A”, also enables an input latch that monitors the photodiode “A”. If, after a suitable waiting period, about 20 microseconds in this case, the latch detects a signal from the photodiode “A”, the logic will record a HIGH for “A”. If the latch does not detect a signal, a LOW will be recorded for “A”. The logic will then repeat the above process for LED “B” and photodiode “B”. These recorded HIGHs or LOWs for the “A” and “B” channels are output at the end of one cycle of an “A” and “B” channel LED pulse and photodiode detection. Then the process will be repeated starting again with the “A” LED and “A” photodiode. The advantage of alternating the “A” and “B” channels is to prevent any cross signals between “A” and “B”. Any stray light from LED “A” that lands on the “B” photodiode is ignored by the logic because the “B” photodiode is not considered during the time the phase “A” LED is on. The reverse is true during the time the “B” LED is on—the “A” photodiode is ignored by the logic. Thus, cross channel interference between “A” and “B” are prevented. As long as the speed or frequency with which the channels are alternated is rapid enough, there is little time-skew or error in the signal between the “A” and “B” channels.

In another embodiment, it is possible to double the resolution derived from the tape through the use of four LEDs and four photodiodes and additional logic. In this embodiment, shown in FIGS. 5a, 5b, and 5c, each channel LED is pulsed and the corresponding photodiode is checked, in the sequence of “A”, “B”, “C”, & “D”. The sequence is then repeated. Again, as long as the sequencing is fast enough, there will not be any significant time-skew between channels. The current embodiment is useful to about 350 feet per minute of speed. Photodiode recorded signals “A” & “B” are 90 degrees from each other. Photodiode recorded signals “C” & “D” are 90 degrees from each other, as seen in FIGS. 5b and 5c. The pair “A” & “B” must be 45 degrees from pair “C” & “D”.

To derive the phase “A” and phase “B” outputs, the “A” and “B” channel photodiode recorded signals in FIGS. 5b and 5c are Exclusive Ored to form the phase “A” output. The “C” and “D” channel photodiode recorded signals are Exclusive Ored to form the phase “B” output. It must be noted that the hole size on the tape must be such that an accurate 90 degrees phase shift exists between photodiode signals “A” & “B” and “C” & “D”.

The logic function 130 in FIGS. 4a and 5a can be implemented in other forms besides an FPGA. Other forms can include software and a microprocessor or in fixed logic. Selector Floor Identification

In FIG. 6 are shown the floor identification signals. When the car is at a floor, the sensors 131, 132, 133, 134, and 135 are aligned with the magnet locations 314, 315, 316, 317, and 318. If a magnet is in the location, the corresponding sensor will detect it. When the car is level at the floor, the logic FPGA 130 detects this from the signals LVU and LVD and enables the output of the signals BPP, BP8, BP4, BP2, & BP1 to the output drivers and thus to the controller. The particular code used in this embodiment is binary for BP1 through BP8 with the BPP as the ODD parity bit.

Selector Leveling and Door Zone

In FIG. 7 is shown the leveling and door zone signals. When the car is at the floor, the sensors 136, 137, 138, 139, 140, 141, 143, 143, 144, & 145 detect a leveling magnet 312. This magnet is 8 inches long in this embodiment. If the car moves off level by going down, then one of the LD1 through LD4 sensors will deactivate. A jumper select selects the particular LED deactivated. This deactivation deactivates the LVD output. The controller will react to this event by raising the car. If the car moves off of level by going up, then one of the LU1 through LU4 sensors will deactivate. A jumper selects the particular sensor. This deactivation deactivates the LVU output. The controller will react to this by lowering the car. This is the continuous relevel function. If the car is stopped for some reason away from the floor, but the leveling magnet 312 activates the selected LVU sensor, the controller will level the car down. If the car is stopped for some reason away from the floor, but the leveling magnet 312 activates the selected LVD sensor, the controller will level the car up. The choice of which LU or LD sensor to use changes the size of the level at the floor zone or the range over which the controller will consider the car level. How large this should be depends on the particular application and drive system.

In FIG. 7 are also shown the Door Zone sensors 140 and 141. They detect the leveling magnet 312 and send signals DZ1 and DZ2 to the controller through a driver. The sensors prevent the car door operator from opening the doors if both sensors are not active. In this embodiment, both sensors are active within about 3 inches of level with the floor.

Selector Directional Limits

In FIG. 8 are shown the directional limit signals. The top directional limit magnet 320 is placed so that it will activate sensor 146 (DLTH) about one inch above the top landing. The signal from sensor 146 will, through logic 130, deactivate and turn off relay 162 and drop the signal DLT to the controller. In turn, this will disable the up movement of the car through various controller means. The bottom directional limit magnet 322 is placed so that it will activate sensor 149 about one inch below the bottom landing. The signal from sensor 149 (DLBH) will, through logic 130, deactivate and turn off relay 163 and drop the signal DLB to the controller. In turn, this will disable the down movement of the car through various controller means. In this embodiment, an additional bi-polar reed switch sensor 147 (DLTR) is near the 146 sensor. This reed switch, when activated, directly removes power from the relay 162 and does not require any active solid-state device to work in order to turn off the relay. This feature is designed to meet certain requirements in the A17 elevator code. In addition, the logic circuit 130 compares the states of sensors 146 and 147. The magnet 320 activates sensor 146 first and then sensor 147 in an up over travel. If sensor 147 is activated, and sensor 146 is not, this would be an error. This could mean that the 146 sensor is non-functional, or it could mean that the magnet 320 is installed with the north side out. This would activate the bi-polar 147 sensor but not the Hall Effect 146 sensor.

Also, an additional bi-polar reed switch sensor 148 (DLBR) is near sensor 149. This reed switch, when activated, directly removes power from the relay 163 and does not require any active solid-state device to work in order to turn off the relay. This is to meet certain requirements in the A17 elevator code. In addition, the logic circuit 130 compares the states of sensors 149 and 148. The 322 magnet activates sensor 149 first and then sensor 148 in a down over travel. If sensor 148 is activated, and sensor 149 is not, this would be an error. It could mean that the 149 sensor is non-functional, or it could mean that the magnet 322 is installed with the north side out. This would activate the bi-polar 148 sensor but not the Hall Effect 149 sensor. Additional logic is included in 130 that disables the error checking for the 146 and 147 sensors if the 149 sensor is activated and the error checking is disabled for the 148 and 149 sensors if the 146 sensor is activated. This is to prevent a false error when the car is run far past the floor and the magnet 320 activates sensors 148 or 149 or if magnet 322 activates sensors 146 or 147. Certain special elevator operations can produce such a situation.

Selector Normal Terminal Slow-Down Bottom, NTSB

FIGS. 9, 10, 11, and 12 show the down direction slow-down portion of the Normal Terminal Slow-down detection function and associated signals, NTSB. It should be noted that these are the back-up slow-downs required at the terminals by the A17 code and not the regular method of slowing the car down. The regular method uses the relative hole count between floors shown in FIGS. 4 and 5, the start the slow-down at a software controlled position count in the hoistway.

In FIGS. 9, 10, 11, 12, for the down direction near the bottom terminal landing, magnet 360 is in the vertical track for NTSB shown in FIG. 15. A continuous magnet, with a south pole on the face, is the actuating magnet for the down terminal slow-down function. This magnet may be one piece or made-up of smaller magnet pieces and butted end-to-end to form a functionally equivalent contiguous south face along its length. Sensors 150, 151, 154, 157, 160 and 161 are the relevant sensors for this function. The signals from these sensors, NTUA, NTUB, NTUC, NTLA, NTLB, NTLC are fed into logic 164 for decoding. Upon appropriate detection of the magnet 360, the logic will drop signal NTSB, Normal Terminal Slow-down Bottom, to the controller. In turn, this will cause the car to slow-down.

The appropriate detection decodes for this embodiment are any of four sets of conditions of activated sensors. They are (NTLC plus NTLB plus NTLA) or (NTLB plus NTLA plus NTUC) or (NTLA plus NTUC plus NTUB) or (NTUC plus NTUB plus NTUA). If any of the four sets of three sensors is activated the logic 164 will drop the signal NTSB, Normal Terminal Slow-down Bottom, to the controller. In turn, this will cause the car to slow down. For positive logic signals, this can be represented in Boolean logic form as (not NTSB)=(NTLC and NTLB and NTLA) or (NTLB and NTLA and NTUC) or (NTLA and NTUC and NTUB) or (NTUC and NTUB and NTUA. The logic 164 is a programmable array logic (PAL) device in this embodiment. Other embodiments may use discrete logic or a microprocessor with software to implement this logic function.

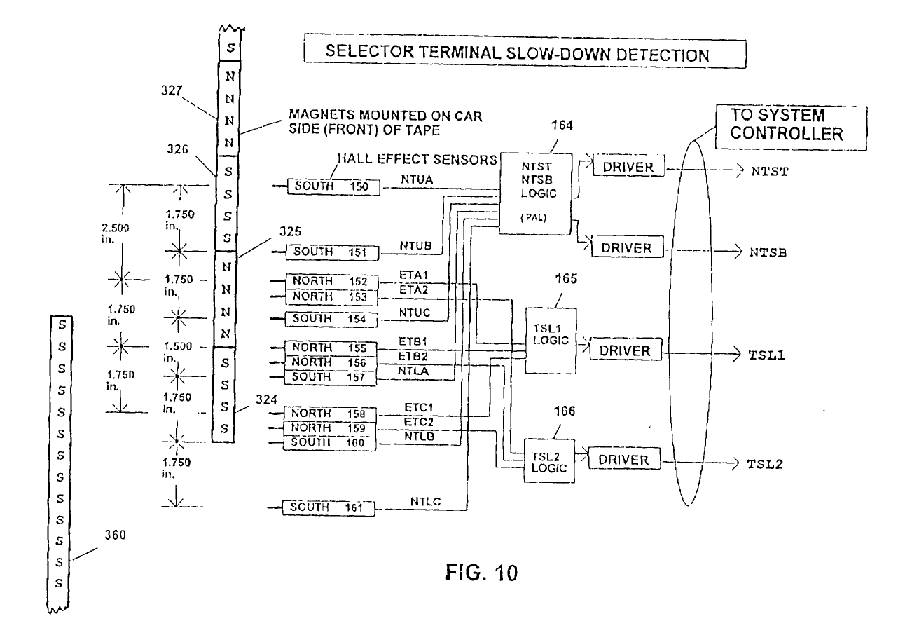

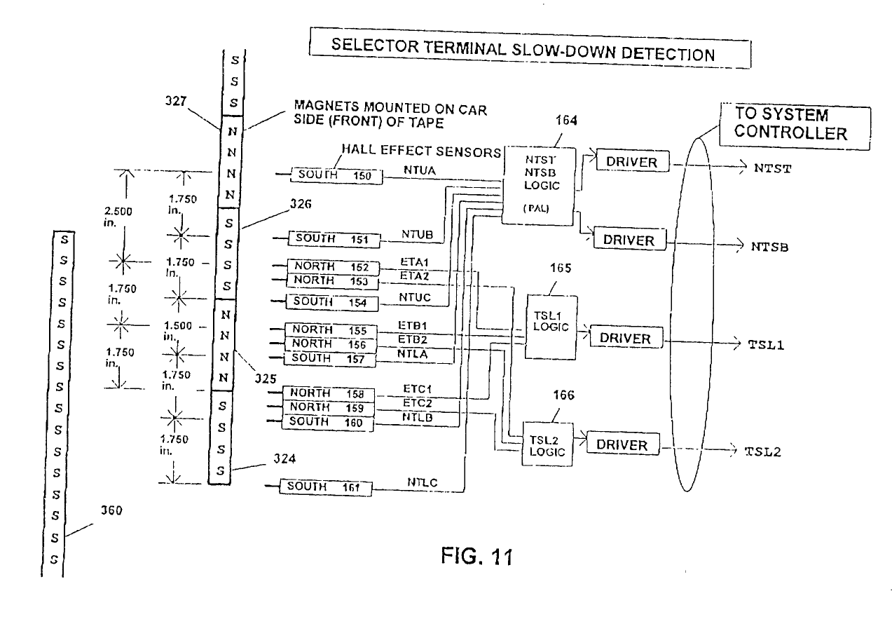

In FIG. 9, for a down run, magnet 360 is shown just activating sensor 157 and also having activated sensors 160 and 161, these are signals NTLA, NTLB and NTLC respectively. This is one of the logic conditions sufficient for logic 164 to drop NTSB. As the car proceeds toward the bottom landing, magnet 360 moves up in relation to the sensors. In FIG. 10, magnet 360 is shown at a vertical position that would just activate sensor 154 as well as having activated 157, 160 and 161. These sensors provide signals NTUC, NTLA, NTLB, and NTLC, respectively to logic 164 for decoding. This combination of four active signals provides two logic conditions to logic 164, (NTLC and NTLB and NTLA), and (NTLB and NTLA and NTUC), either one of which is sufficient for the logic 164 to drop NTSB. In FIG. 11, magnet 360 is shown at a vertical position that would just activate sensor 151 as well as having activated 154, 157, 160 and 161. These sensors provide signals NTUB, NTUC, NTLA, NTLB, and NTLC, respectively to logic 164 for decoding. This combination of five active signals provides three logic conditions to logic 164, (NTLC and NTLB and NTLA), (NTLB and NTLA and NTUC), and (NTLA plus NTUC plus NTUB), any one of which is sufficient for the logic 164 to drop NTSB.

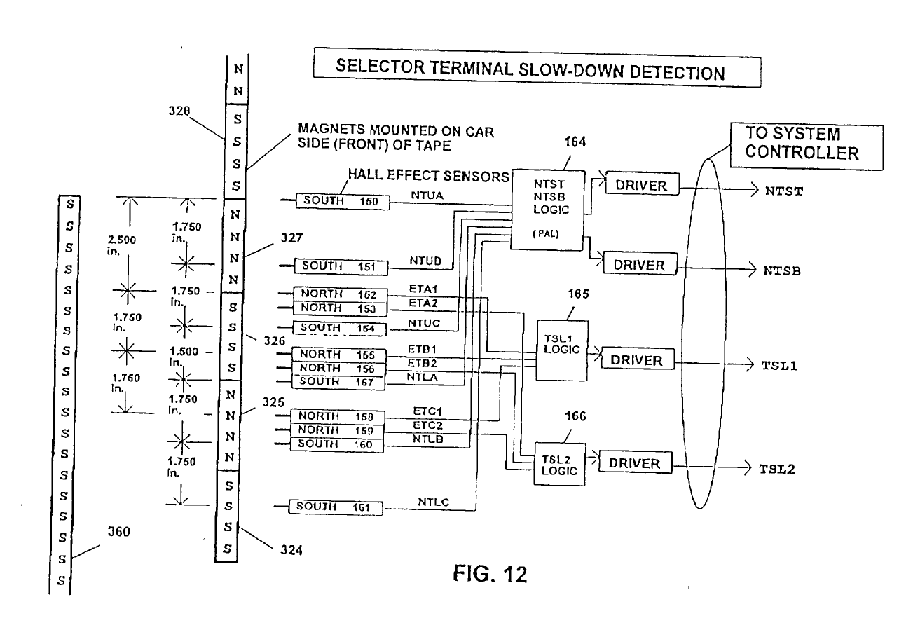

In FIG. 12, magnet 360 is shown at a vertical position that would just activate sensor 150 as well as having activated 151, 154, 157, 160 and 161. These sensors provide signals NTUA, NTUB, NTUC, NTLA, NTLB, and NTLC, respectively to logic 164 for decoding. This combination of six active signals provides four logic conditions to logic 164, (NTLC and NTLB and NTLA), (NTLB and NTLA and NTUC), (NTLA plus NTUC plus NTUB), and (NTUC plus NTUB plus NTUA) any one of which is sufficient for the logic 164 to drop NTSB. As the car continues to the bottom landing, the magnet 360 is long enough to keep the sensors active if and until the car goes past the bottom floor and the bottom directional limit DBL is activated.

The first logic condition is sufficient for proper operation and the single logic condition of (NTLC and NTLB and NTLA) will operate correctly. By utilizing the other three signals of NTUA, NTUB and NTUC, robustness of this function in increased. This improvement is because, for example, a failure of sensor 161 or the loss of signal NTLC would be replaced by the next logic condition of (NTLB and NTLA and NTUC). This is slightly further toward the landing, but a late terminal slow-down is better than a total failure if the one sensor 161 is lost. Thus, utilizing the four logic conditions of (NTLC and NTLB and NTLA) or (NTLB and NTLA and NTUC) or (NTLA and NTUC and NTUB) or (NTUC and NTUB and NTUA) increases the robustness of the function. As a practical matter, in this particular embodiment, the additional sensors required are already in place for use by the up direction terminal slow-down and there is no additional cost to implement the additional logic in the logic device 164 due to its having gates available.

Selector Normal Terminal Slow-Down Top, NTST

In FIGS. 9, 10, 11, 12, for the up direction near the top terminal landing, a series of magnets in the vertical track for NTST, shown in FIG. 15, contain the actuating magnets for the slow-down portion of the up Normal Terminal Slow-down function, NTST. This series of magnets start with magnet 324, with a south polarity on its face. In this embodiment, magnets 324, 325, etc., are 2.5 inches long. Next to and above magnet 324 is magnet 325. Magnet 325 has a north polarity on its face. Next to and above 325 is magnet 326 with a south polarity on its face. This alternating pattern continues up the hoistway on the tape 300 a sufficient distance for the car to reach the upper directional limit such that the selector sensors detect the DLT signal from magnet 320 in FIG. 8. The relevant actuating magnets for the NTST function are the south faced magnets.

Like the down terminal limits described above, sensors 150, 151, 154, 157, 160 and 161 are the relevant sensors for this function. The signals from these sensors, NTUA, NTUB, NTUC, NTLA, NTLB, NTLC are fed into logic 164 for decoding. Upon appropriate detection of the series of magnets starting with magnet 324, the logic will drop signal NTST, Normal Terminal Slow-down Top, to the controller. In turn, this will cause the car to slow-down.

The appropriate detection decodes for this embodiment is any of six sets of conditions of three sensors each. The six sets are (NTUA plus not NTUB plus NTLA) or (NTUA plus not NTUC plus NTLA) or (NTUB plus not NTUC plus NTLB) or (NTUB plus not NTLA plus NTLB) or (NTUC plus not NTLA plus NTLC) or (NTUC plus not NTLB plus NTLC). If any of the six sets of three sensors is in the condition listed above the logic 164 will drop the signal NTST, Normal Terminal Slow-down Top, to the controller. In turn, this will cause the car to slow down. For positive logic signals, this can be represented in Boolean logic form as (not NTST)=(NTUA and (not NTUB) and NTLA) or (NTUA and (not NTUC) and NTLA) or (NTUB and (not NTUC) and NTLB) or (NTUB and (not NTLA) and NTLB) or (NTUC and (not NTLA) and NTLC) or (NTUC and (not NTLB) and NTLC). As stated before, the logic 164 is a PAL device in this embodiment. Other embodiments may use discrete logic or a microprocessor with software to implement this logic function.

In FIG. 9, for upward movement of the car, the leading edge of magnet 324 is shown just actuating sensor 157, signal NTLA, and having activated sensor 156, signal NTUC, magnet 325 is shown as not activating sensor 151, signal NTUB, magnet and magnet 326 is shown just actuating magnet 150, signal NTUA. Logically this is NTLA and NTUC and (not NTUB) and NTUA. This meets the criteria of (NTUA and (not NTUB) and NTLA). This is one of the six sets of logical conditions sufficient for logic 164 to drop NTST.

As the car proceeds toward the top landing, the series of magnets starting with magnet 324 moves down in relation to the sensors. At some point before magnet 324 reaches the point at which it activates sensor 160, it will still activate 157, signal NTLA, but will no longer activate 154, signal NTUC, magnet 325 will still not activate 151, signal NTUB, and 326 will still activate 150, signal NTUA. Logically this is NTLA and (not NTUC) and (not NTUB) and NTUA. This meets the criteria of (NTUA and (not NTUB) and NTLA), and it meets the criteria of (NTUA and (not NTUC) and NTLA).

As the car proceeds further toward the top landing, the series of magnets starting with magnet 324 moves further down in relation to the sensors. In FIG. 10, magnet 324 is shown at a vertical position that would just activate sensor 160, signal NTLB, as well as having activated 157, signal NTLA. Magnet 325 does not activate 154, signal NTUC. Magnet 326 just activates 151, signal NTUB as well as having activated 150, NTUA. Logically this signals NTLB, NTLA, (not NTUC), NTUB, and NTUA. This meets criteria (NTUA and (not NTUC) and NTLA) and criteria (NTUB and (not NTUC) and NTLB).

As the car proceeds toward the top landing, the series of magnets starting with magnet 324 moves down in relation to the sensors. At some point before magnet 324 reaches the point at which it activates sensor 161, it will still activate 160, signal NTLB, but will no longer activate 157, signal NTLA, magnet 325 will still not activate 154, signal NTUC, magnet 326 will still activate 151, signal NTUB, but will no longer activate 150, NTUA. Logically this is NTLB and (not NTLA) and (not NTUC) and NTUB and (not NTUA). This meets criteria (NTUB and (not NTUC) and NTLB) and criteria (NTUB and (not NTLA) and NTLB). The (not NTUA) is ignored at this point.

Again as the car proceeds further toward the top landing, the series of magnets starting with magnet 324 moves further down in relation to the sensors. In FIG. 11, magnet 324 is shown at a vertical position that would just activate sensor 161, signal NTLC, as well as having activated 160, signal NTLB. Magnet 325 does not activate 157, signal NTLA. Magnet 326 just activates 154, signal NTUC as well as having activated 151, NTUB. Logically this is NTLC, NTLB, (not NTLA), NTUC, and NTUB. This meets criteria (NTUB and (not NTLA) and NTLB), criteria (NTUC and (not NTLA) and NTLC).

As the car continues to proceed toward the top landing, the series of magnets starting with magnet 324 moves down in relation to the sensors. At some point before magnet 326 reaches the point at which it activates sensor 157, magnet 324 will still activate 161, signal NTLC, but will no longer activate 160, signal NTLB, magnet 325 will still not activate 157, signal NTLA, and will not activate 160, signal NTLB, magnet 326 will still activate 154, signal NTUC, magnet 327 will not activate 151, signal NTUB, and still will not activate 150, signal NTUA. Logically this is NTLC, (not NTLB), (not NTLA), NTUC, (not NTUB), (not NTUA). This meets criteria (NTUC and (not NTLA) and NTLC) and criteria (NTUC and (not NTLB) and NTLC).

Then, as the car proceeds further toward the top landing, the series of magnets starting with magnet 324 moves further down in relation to the sensors. In FIG. 12, the series of magnets are shown at a vertical position in which magnet 326 would just activate sensor 157, signal NTLA, as well as having activated 154, signal NTUC. Magnet 324 would have activated 161, signal NTLC, magnet 325 does not activate 160, signal NTLB. Magnet 327 does not activate 151, signal NTUB, magnet 328 just activates 150, signal NTUA. Logically this is NTLA, NTUC, NTLC, (not NTLB), (not NTUB), NTUA. This meets criteria (NTUB and (not NTLA) and NTLB) and criteria (NTUC and (not NTLA) and NTLC) and it also meets the first criteria of (NTUA and (not NTUB) and NTLA). With magnet 326 just activating 157, and magnet 328 just activating 150, this is where a repeating cycle of the six criteria starts over again. This cycle will continue up the hoistway until the top directional limit is reached at DLT in FIG. 8. Thus, NTST will be off and the car will be in slow-down in this region where the above criteria are met.

Selector Emergency Terminal Speed Limiting, TSL1 & TSL2

FIGS. 9, 10, 11, and 12 show the Emergency Terminal Speed Limiting detection and associated signals, TSL1and TSL2. As noted for the Normal Terminal Slow-down, these are the back-up slow-downs required at the terminals by the A17 code and not the regular method of slowing the car down. The regular method uses the relative hole count between floors shown in FIGS. 4 and 5, to start the slow-down at a software controlled position count in the hoistway.

In FIGS. 9, 10, 11, 12, for the up direction near the top terminal landing, a series of magnets in the vertical track for TSL1 and TSL2, shown in FIG. 15, contain the actuating magnets for the up Emergency Terminal Speed Limiting functions. This function is just a redundant up terminal slow-down like the NTST. This series of magnets starts with magnet 324, with a south polarity on its face. In this embodiment, magnets 324, 325, Etc. are 2.5 inches long. Next to and above 324 is magnet 325. Magnet 325 has a north polarity on its face. Next to and above 325 is magnet 326 with a south polarity on its face. This alternating pattern is the same as that used for the NTST function, and continues up the hoistway on the tape 300 a sufficient distance for the car to reach the upper directional limit such that the selector sensors detect the DLT magnet 320 in FIG. 8. The relevant actuating magnets for the TSL1 and TSL2 functions are the north faced magnets.

Sensors 152, 155, and 158 are the relevant sensors for the TSL1 function. The signals from these sensors are ETA1, ETB1, and ETC1 and are fed into logic 165 for decoding. Sensors 153, 156, and 159 are the relevant sensors for this function. The signals from these sensors are ETA2, ETB2, and ETC2 and are fed into logic 166 for decoding.

Upon appropriate detection of the series of magnets starting with magnet 325, the logic 165 will drop signal TSL1 and logic 166 will drop signal TSL2. The TSL1 and TSL2 functions are redundant to each other for the purpose of protection against a single failure. A single failure of one will not prevent the other from functioning.

The appropriate detection for this embodiment is actuation of any of the three sensors 152, 155 or 158 (signals ETA1, ETB1 or ETC1) will cause logic 165 to drop TSL1 to the controller. In turn the car will be slowed down. The actuation of any of the three sensors 153, 156 or 159 (signals ETA2, ETB2 or ETC2) will cause logic 166 to drop TSL2 to the controller. In turn the car will be slowed down.

In FIG. 9, the magnet 325 is shown just actuating 152 as magnet 324 just actuates 157 and magnet 326 just actuates 150. Thus, TSL1 will be dropped at the same point in the hoistway as the NTST function. Magnet 325 will actuate 153 a very short distance after 152. This means that at a short distance after NTST and TSL1 are dropped, the TSL2 will be dropped. This distance is 0.2 inches in this embodiment. This distance is functionally insignificant.

As the car moves up, the magnets move down in relation to the sensors. In FIG. 10 magnet 325 is shown still actuating 152 and 153 and just actuating 155. Thus TSL1, and TSL2 are still dropped as well as NTST (See the paragraphs on the NTST above for these same figures.)

FIG. 11 shows the car moved further up the hoistway. Magnet 325 is no longer actuating 152 or 153, but still actuating 155 and 156 and just actuating 158. Again, TSL1, TSL2 and NTST are still dropped.

FIG. 12, with the car further up the hoistway, shows magnet 325 no longer actuating 155 and 156 but still actuating 158 and 159. Magnet 327 is just actuating 152. Again, TSL1, TSL2, and NTST are still dropped. FIG. 12 shows the start of the repeating of the cycle of the various criteria for the NTST, TSL1, and TSL2. This cycle will continue up the hoistway until the top directional limit is reached at DLT in FIG. 8. Thus, TSL1, and TSL2 will be off and the car will be in slow-down in this region where the above criteria are met.

It should be noted that the magnets in the series starting with 324 are, in this embodiment, 2.5 inches long. The spacing between the sensors 150, 151, 154, 157, 160 and 161 is 1.75 or 1.5 inches. This means that each magnet spans across successive sensors. There is sufficient overlap so that the next logic condition is securely established before the previous logic condition is lost. Thus, the appropriate state of NTST, TSL1 and TSL2 are maintained, even though there are alternating magnet polarity and a corresponding alternating state of the sensors. It is this overlap of the magnet polarity pattern with the sensors that produces the necessary logic states that is key to allowing the Emergency Terminal Speed Limiting function, TSL1, TSL2, to operate in an interlaced manner with the Normal Terminal Slow-down Top, NTST, without one function's magnets interfering with or potentially operating the other functions sensors. The NTST function uses South faced magnets and the sensors for the NTST function only activate with south faced magnets. The TSL1, and TSL2 functions only activate to north faced magnets. If the north faced magnets were to be removed, without disturbing the south faced magnets, the NTST function would still operate, but the TSL1 and TSL2 would not. In reverse, if only the south faced magnets were removed from the alternating pattern, then the TSL1 and TSL2 function would work but the NTST function would not. Thus, due to the spatially coded alternating magnets, NTST, TSL1, and TSL2 operate in practically the same vertical location of the car selector and in the same track, but with functional independence between the NTST and the TSL1 and TSL2.

In certain embodiments of the this system, in conjunction with certain embodiments of the car control system, detection of missing or reversed magnets is possible during an initial set-up scan of the hoistway performed by the car control system in which the selector outputs are checked against expected signals along the tape. Missing or reversed magnets will produce missing or incorrect signals. This is in addition to the detection of reversed polarity directional limit magnets (DLT and DLB signals) incorporated into the selector 130 in FIG. 8

### DETECTION CIRCUIT

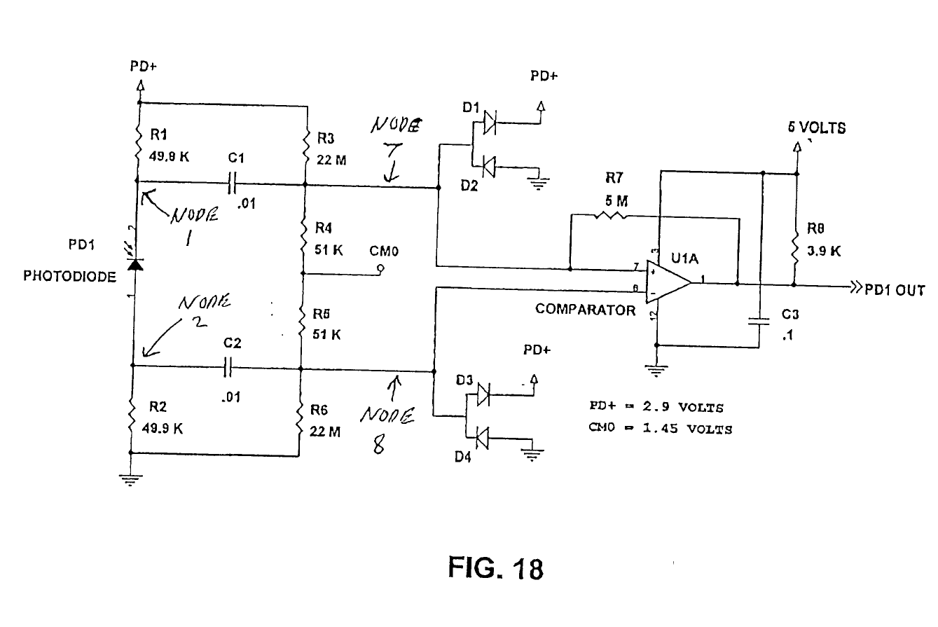

In FIG. 4a are shown detection circuits 132 and 134, and in FIG. 5a are shown detection circuits 132, 134, 136, and 138. In FIG. 18 is the schematic of one of the photodiodes and one of the detection circuits (132, 134, 136, or 138) used to detect the holes in the tape. In this circuit, the photodiode PD1 is reversed biased by voltage PD+(2.9 volts) through resistors R1 and R2. Node 1 is connected to node 7 by capacitor C1. C1 and R4 form a high pass filter. Node 2 and node 8 are connected by capacitor C2. C2 and R5 form a high pass filter. D1 through D4 prevent large voltage excursions beyond the comparator's range to prevent slow recovery due to large ambient light changes. Node 7 and node 8 are close to the center voltage CM0, (1.45 volts) with node 7 pulled up a few millivolts above CM0 by R3, and node 8 pulled down a few millivolts below CM0 by R6. Comparator UIA has an output that is high when node 7 is positive with respect to node 8.

When a pulse from an LED shown in FIGS. 4 and 5 sends infrared light through a hole 310 on tape 300 and is received by photodiode PD1, the diode conducts current. It also conducts current due to ambient light. The current involved is very small, typically in the 3-microampere range. Typical circuits recommended for use with photodiodes involve using amplifiers to amplify the current with either a fixed wide dynamic range amplifier or a self-adjusting variable gain amplifier to useful level and then use this high level signal to do detection. In this application, ambient light changes at a relatively low frequency. The LED pulse sent to the photodiode is in the 5-microsecond range. By placing a high pass filter in the form of C1, C2, R4, and R5, direct current and low frequency signals are blocked,, but the high frequency 5 microsecond pulse from the LED is passed. The pulse will cause the photodiode PD1 to increase conduction rapidly. This rapid conduction causes the voltage between node 1 and node 2 to be reduced rapidly. This in turn causes the capacitor C1 to drive node 7 below CM0 and it causes C2 to drive node 8 above CM0. The result is that the pulse causes nodes 7 and 8 to reverse polarity. Comparator UIA detects this and its output goes low. Slowly changing ambient light does not cause the polarity change of nodes 7 and 8 due to the high pass filters of C1, R4 and C2, R5. Unlike amplifier circuits, this circuit works the same over a wide range of ambient light because it only detects the high-speed pulse. The output of the comparator is high or low and thus it is compatible with the digital input the logic circuit 130 requires. Thus, the circuit directly digitizes the analog signal from the photodiode.

Because this circuit would be subjected to considerable electromagnetic interference (EMI), the circuit is balanced differential and symmetrical about the CM0 point. This fact and a balanced symmetrical printed circuit board layout prevent electrical noise form producing false signals in the circuit.

### SELECTOR ENCLOSURE

Captive Components

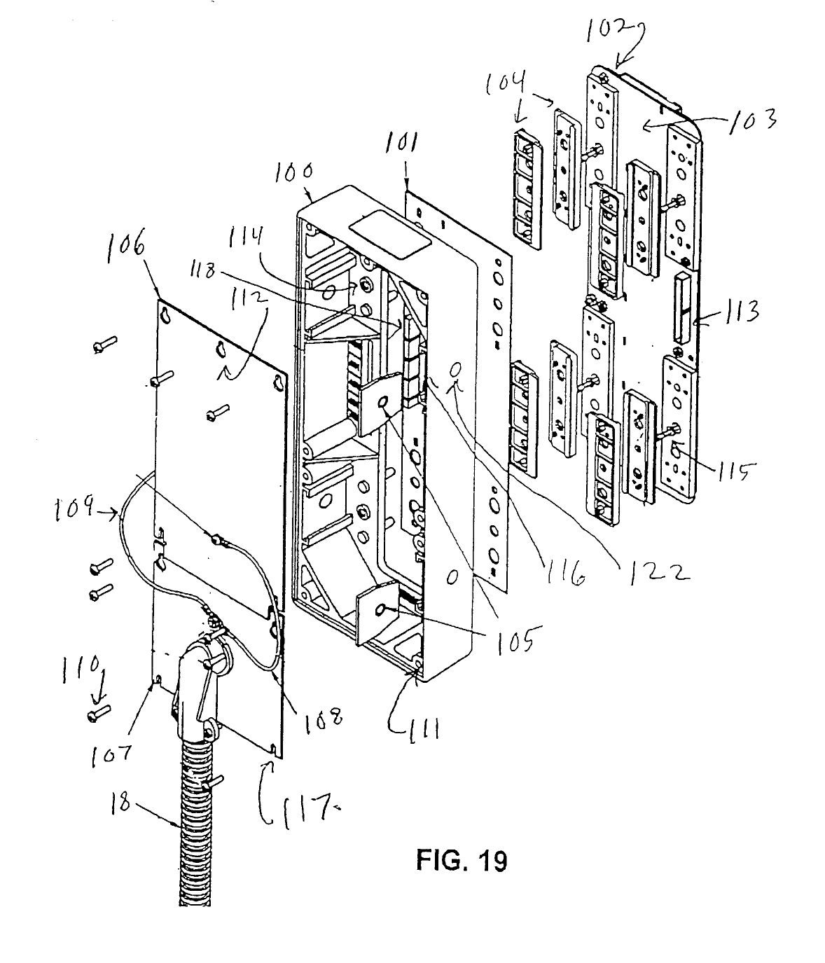

FIG. 19 shows an exploded view of the advantageous new selector enclosure and the various components that attach to it. This view is from the opposite side of FIG. 2. Harness 18 is attached to harness plate 107. Harness plate 107 is bolted to enclosure body member 100 with screws 110 that go into brass inserts 111 seated in the molded enclosure body member 100. Tether and ground wire 108 tethers cover 106 to harness plate 107. Tether and ground wire 109 tethers auxiliary assembly 102 to harness plate 107. Cover 106 is bolted to enclosure body member 100 with screws 110 that go into brass inserts 111 seated in the molded enclosure body member 100. The cover 100 and the harness plate have “key-holes” 112 and slots 117 that allow removal of the cover 110 and harness plate 107 without total removal of the screws 110. Nut plates 105 are captive in the enclosure body member 100 in which a cavity 116 is molded to hold the nut plate 105. FIG. 24 shows a detail of this cavity 116. Printed Circuit Board, PCB 103 is part of assembly 102. Assembly 102, tape guides 104 and PCB 101 form a sandwich and are bolted to the enclosure body member 100 by thumb screws 115. Thumb screws 115 mate with brass inserts 114 in the enclosure.

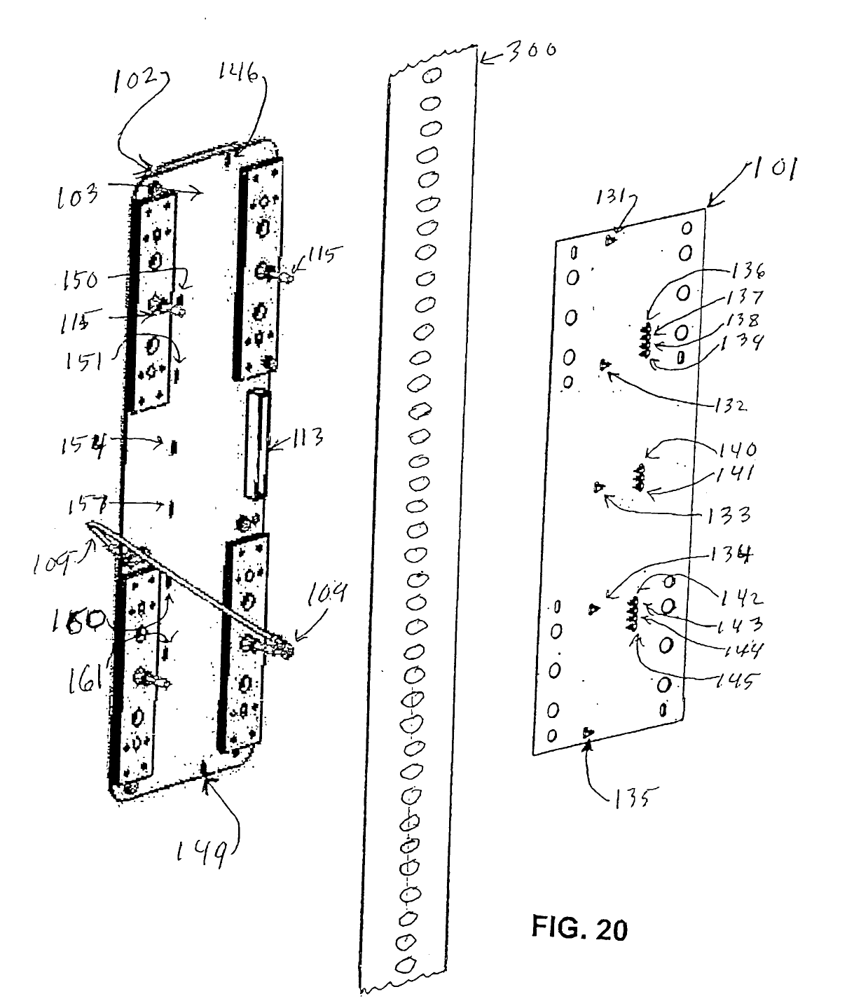

PCB 101 connects electrically with PCB 103 through a connector set 113 with half the set on 101 and the mating half on 103. Connectors 118 on PCB 101 mate with receptacles on the harness 18. Thus it can be seen that all components are, during normal installation and maintenance, attached to prevent dropping them down the hoistway. The exceptions to this are the tape guides 104. PCB 101, while not completely captive when assembly 102 is removed for installation, is effectively tethered by the harness 18. During installation, the assembly 102 is removed and the tape 300 is inserted between the tape guides 104 and between the PCBs 101 and 103. See FIGS. 19 and 20.

Printed Circuit Boards

FIG. 20 shows PCB 101. It is the TMS or Tape Selector Main printed circuit board. It contains sensors 131, 132, 133, 134, 135, 136, 137, 138, 139, 140, 141, 142, 143, 144, 145 that are shown in FIGS. 6 and 7. It also contains the photodiodes shown in FIGS. 4a and 5a. The TSM 101 contains the logic 130, 164, 165 and 166, and various other support electronics for this particular embodiment. Also, FIG. 20 shows PCB 103. It is the TSA or Tape Selector Auxiliary printed circuit board. It contains sensors 146, 147, 148, 149, 150, 151, 152, 153, 154, 155, 156, 157, 158, 159, 160, 161 that are shown in FIGS. 8, 9, 10, 11, and 12. It also contains a small amount of support electronics for this particular embodiment.

### SELECTOR ENCLOSURE CONSTRUCTION

Gussets

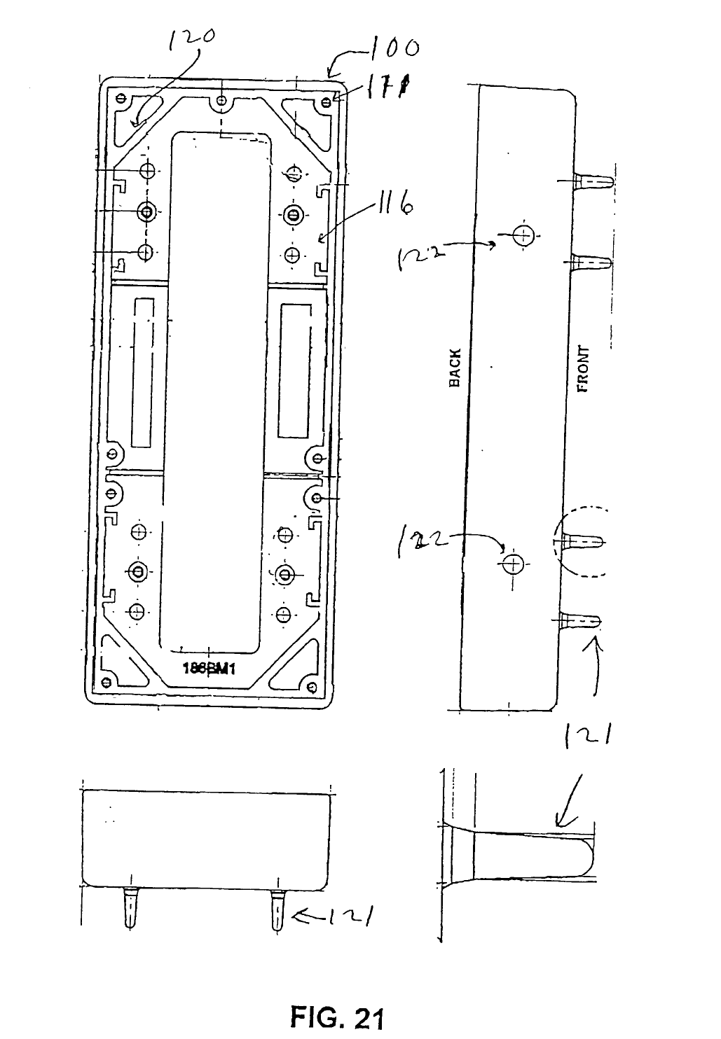

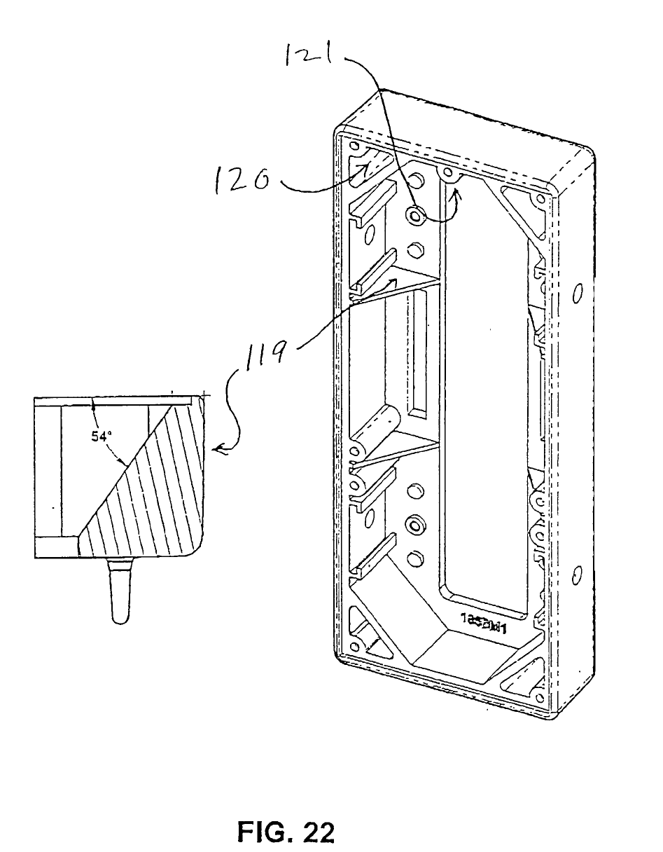

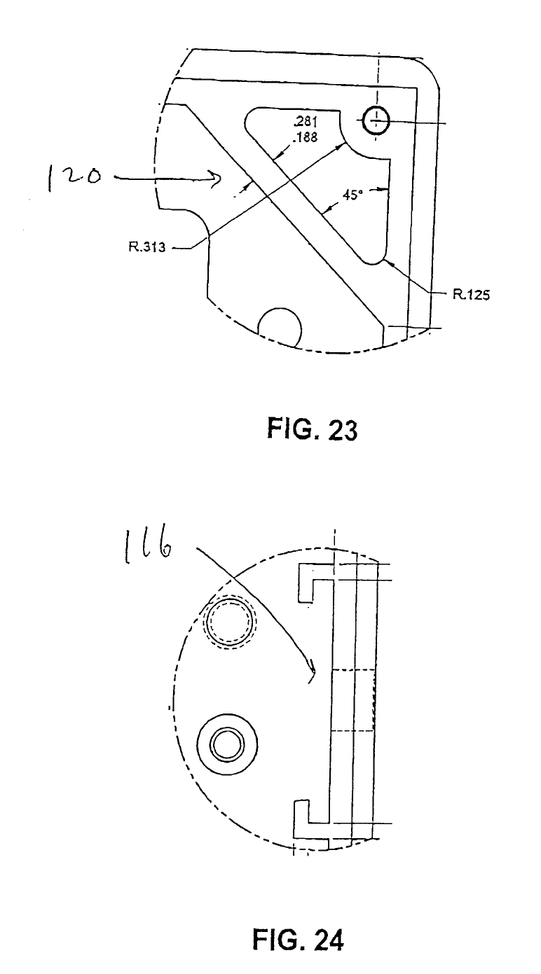

In FIGS. 21, 22, and 23 are shown gussets 119 and 120 that are designed to greatly increase the strength of the enclosure. Though engineering analysis it was determined that the addition of an additional attachment 121 (seen in FIG. 22), for the cover also added to the overall strength of the enclosure. Engineering analysis indicates that this particular embodiment will withstand a 250 lb load applied to the top of the enclosure when the enclosure is made of structural foam injection molded polycarbonate FL900 or equivalent. Advantageous placement and size of the gussets and cover attachments make this a particularly robust embodiment.

Alignment Pins

FIG. 21 shows that the enclosure has alignment pins 121 molded into the front of the enclosure. These pins are an aid during installation and will hold the PCBs 101 and 103 and the tape guides 104 during assembly and during the installation of the tape into the selector enclosure. This allows a tactile installation in places where visibility is poor or nonexistent. The pins 121 go through the PCBs and the tape guides 104.

Nut Plates

FIG. 19 shows nut plates 105. The mounting bracket 400 in FIG. 3, used to hold the enclosure body member 100 to the car stile 402, is bolted to the enclosure through the bracket 400, through holes 122 in the enclosure and into nut plates 105 in cavities 116. Instead of nuts or inserts in the plastic enclosure body member 100, nut plates 105 are used, along with the cavities 116 to provide a means of transferring the load of the enclosure to the mounting bolts without over-stressing the plastic. These nut plates 105, by being removable, allow two nut plates to be sufficient for right and left hand installations. If an opposite hand is required, the two plates are removed, reversed, and reinstalled on the opposite side. They provide a secure and lower stress method of attachment over regular nuts and bolts or brass inserts in the plastic.

### ALIGNMENT TOOL

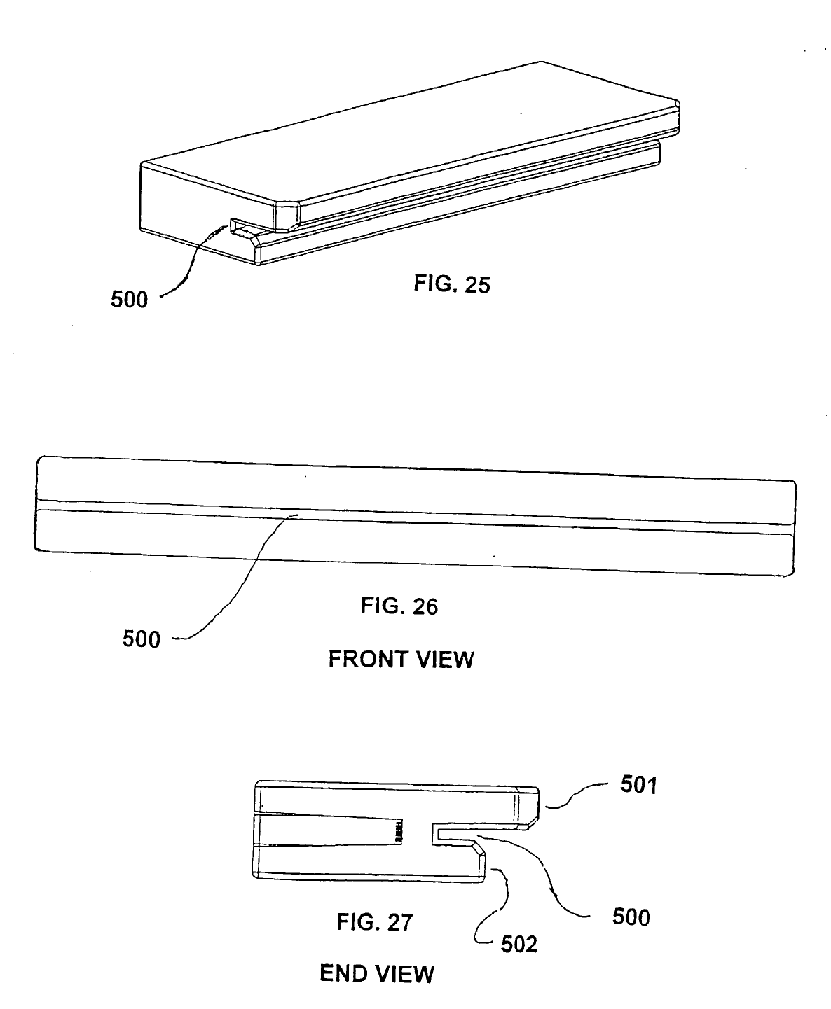

FIGS. 25, 26 and 27 show the alignment tool and crevice or slot 500. When placing magnets on the often difficult to see back side of the tape as shown in FIG. 17, the tool is placed against the tape with the tape edge inside the crevice or slot. The longer lip of the tool, FIG. 27, 501, is used on the back side of the tape. The shorter lip, FIG. 27, 502, is on the front side. With the tool in this position, it is possible to use one hand to both hold to tool and use the fingers of that same hand to pull each magnet edge against the edge of the tool for proper horizontal of the magnets on the back side of the tape. The tool can be slid up on down the tape for complete alignment of the magnets on a particular side of the tape. The tool can then be moved to the other side of the tape to align the magnets on that side. All of this is done tactilely with little or no visibility. The tool's short lip, FIG. 27, 502, is shorter to prevent interference with the magnets on the front side of the tape.

What is claimed is:

1. An elevator selector system for use with an elevator system having an elevator car that is vertically displaceable in a hoistway and a controller for controlling the car's vertical movement, the selector system comprising:
a selector housing mounted to the elevator car;
a first and second light emitting device mounted in the selector housing, the first light emitting device located vertically above the second light emitting device;
a first and second light sensor, the first light sensor mounted in the selector housing horizontally in line with the first light emitting device, the second light sensor mounted in the selector housing horizontally in line with the second light emitting device;
a tape vertically mounted in the hoistway, the tape passing between the first light emitting device and the first light sensor and passing between the second light emitting device and the second light sensor;
a logic circuit for controlling the outputs of the light emitting devices and for decoding signals from the light sensors; and
a wiring harness for connecting the logic circuit to the controller.

2. The selector system of claim 1, further comprising:
a plurality of magnetic sensors for sensing the presence and polarity of magnets, the sensors spatially distributed vertically within the selector housing; and
a plurality of magnets disposed on the tape.

3. The selector system of claim 1 or 2, wherein the light sensing devices comprise light emitting diodes and the light sensors comprise photodiodes.

4. The selector system of claim 3, wherein the light emitting diodes are infrared light emitting diodes.

5. The selector system of claim 4 further comprising: a differential circuit with pass filtration electrically connected to the photodiodes for minimizing the effect of ambient light on the diodes.

6. An elevator selector system for use with an elevator system having an elevator car operating in a hoistway and a controller for controlling the car, the selector system comprising:
a tape mounted to the hoistway, the tape having two opposing surfaces;
a selector housing mounted to the car, the selector housing having a plurality of openings through which the tape passes;
a normal terminal slow down bottom means;
a normal terminal slow down top means;
an emergency terminal speed limiting one means;
an emergency terminal speed limiting two means;
a directional limit top means;
a directional limit bottom means;
a wiring harness for connecting components in the selector housing to the elevator controller.

7. The selector system of claim 6, wherein the tracks are mounted on both surface of the tape.

8. The selector system of claim 6, further comprising a means for detecting reversed polarity directional limits.

9. The selector system of claim 8, wherein the means for detecting reversed polarity directional limits comprises a quadrature hole counting detection means.

10. The selector system of claim 6, wherein the normal terminal slow down bottom means, the normal terminal slow down top means, the emergency terminal speed limiting one means, and the emergency terminal speed limiting two means occupy a single vertical location within the selector housing.

11. A method for quadrature hole counting for use in determining relative position and speed of an elevator car in an elevator system comprising a pair of light emitting devices and corresponding light sensing devices, the method comprising:
sequentially pulsing the pair of light emitting devices; and
selectively activating the light sensing devices independently so that only one sensor is active at any time.

12. The method of claim 11, further comprising:
reverse biasing the light sensing devices;
filtering the output of the light sensing devices with a high pass filter; and
the filtered output to a comparator.

13. A differential circuit comprising:
a reverse biased photodiode;
a plurality of high pass filters electrically connected to the photodiode; and
a comparator electrically connected to the high pass filters.

14. The differential circuit of claim 13, further comprising a CMO point.

15. The differential circuit of claim 14, wherein the circuit is balanced about the CMO point.

16. A method for preventing loss of selector components in an elevator system during servicing of the selector components, the method comprising:
tethering a first selector component to a selector housing prior to installing the component and housing in the elevator system; and
installing the component and housing in the elevator system.

17. A selector enclosure apparatus comprising:
a housing member;
a first cover plate;
a second cover plate; and,
one or more tethers for tethering the cover plates to the housing member.

18. The selector enclosure apparatus of claim 17, wherein the tethers comprise a ground wire.

19. The selector enclosure apparatus of claim 18, further comprising a printed circuit board mounted to one of the cover plates.

20. The selector enclosure apparatus of claim 19, further comprising a wiring harness.

21. The elevator selector enclosure apparatus of claim 20, further comprising a second printed circuit board secured to the wiring harness.

22. An elevator selector enclosure for use with an elevator car, the elevator selector enclosure comprising
a body member having four sides and four corners; two sides adjoining each other at each corner, the body member also having a front and back for mounting covers;
gussets in each corner of the body member for adjoining two sides of the body member;
alignment pins protruding from the front and back of the body member for aiding in tactile assembly of the enclosure; and,
nut plates mounted to the body member for bolting the enclosure to the elevator car.

23. The elevator selector enclosure of claim 22 wherein the enclosure is manufactured from structural foam injection molded polycarbonate.

24. A method for assembling an elevator selector comprising:
mounting a selector enclosure to an elevator car; and
tactile mounting a plurality of components to the enclosure with the aid of a plurality of alignment pins.

25. A selector for a system having a moving part that is linearly displaceable between locations and that requires multiply redundant linear position or zone information about said moving part, the selector comprising:
a linear track including a first set of magnets comprising equal length strip magnets placed end-to-end with an alternating North and South polarity on their face along said track for identification of a first position or zone with quantity of alternating magnets sufficient to form required length for said position or zone and a second set of magnets comprising strip magnets placed end-to-end with all South polarity on their face along said track for identification of a second position or zone with quantity of magnets sufficient to form required length for said position or zone;
a selector unit including a selector housing or enclosure mounted on said moving part, aligned with guide means for maintaining precise positioning in plane perpendicular to the travel of said linear track relative to the magnets, and a first set of three North only sensing sensors, and a second set of three North only sensing sensors, and a third set of six South only sensing sensors spatially distributed and mounted within or on said housing linearly in the direction of said linear movement in such a way as to be actuated respectively by said North or South faced strip magnets;
the first set of magnets having a linear spacing that is less than the length of said strip magnets such that one said North faced magnet's actuation range can actuate any two, but not all three of said first set of three North sensing sensors such that at least one of the said sensors is actuated when said moving part is within the particular zone defined by said first set of alternating strip magnets;
the second set of magnets having a linear spacing that is less than the length of said strip magnets such that one said North faced magnet's actuation range can actuate any two, but not all three of said second set of three North sensing sensors such that at least one of the said sensors is actuated when said moving part is within the particular zone defined by said first set of alternating strip magnets;
the first set of sensors and said second set of sensors being interlaced such that the first sensor of the said first set and the first sensor of the said second set are spaced linearly along said track as close to each other as practical, the second sensor of the said first set and the second sensor of the said second set are spaced linearly along said track as close to each other as practical, the third sensor of the said first set and the third sensor of the said second set are spaced linearly along said track as close to each other as practical so as to have the respective first, second and third sensor actuation points for a particular magnet practically in the same location for said first and second set;
the third set of magnets having a linear spacing that is less than the length of said strip magnets such that one said South faced magnet's actuation range of the first set of alternating magnets can actuate any two, but not three of said third set of six South sensing sensors;
the third set of six South sensing sensors arranged such that the first South faced magnet of the said first set of alternating magnets will actuate the forth sensor of the said third set of six South sensing sensors at the same location of the said moving part as the second South faced magnet of the said first set of alternating magnets actuates the first sensor of the said third set of six South sensing sensors, and said first magnet actuates said fifth sensor at the same point as said second magnet actuates said second sensor, and said first magnet actuates said sixth sensor at the same point as said second magnet actuates said third sensor;
the third set of six South sensing sensors arranged such that as said moving part enters into a zone defined by said first set of alternating magnets, a sequence of six relevant logical combinations of sensor actuation states occur to said sensors, those six relevant combinations being (first and forth and not second), (first and forth and not third), (second and fifth and not third), (second and fifth and not forth), (third and sixth and not forth), and (third and sixth and not fifth);
the third set of sensor and said first set of sensors being interlaced such that at a point at which said first North faced magnet actuates said first sensor of said first set of North sensing sensors, the said first combination of sensor actuation states said third set of South sensing sensors also occurs, and in which at the point at which said first North faced magnet actuates said second sensor of first set of North sensing sensors, the said third combination of sensor actuation states of said third set of South sensing sensors also occurs, and in which at the point at which said first North faced magnet actuates said third second sensor of first set of North sensing sensors, the said fifth combination of sensor actuation states of said third set of South sensing sensors also occurs;
the third set of six South sensing sensors arranged such that as said moving part enters into a zone defined by said second set of South facing polarity strip magnets, a sequence of four relevant logical combinations of sensor actuation states occur to said sensors, those four relevant combinations being (sixth and fifth and forth), (fifth and forth and third), (forth and third and second), and (third and second and first);
a first logic circuit for decoding the said six combinations of said six South sensors to derive a constant detection signal from the over-lapping sequence of the said six combinations and for decoding said 4 combinations of said 6 South sensors to derive a constant detection signal from overlapping sequence of said 4 combination;
a second logic circuit for decoding the 3 signals from said set of 3 sensors of the first set of said North sensors to derive a constant detection signal from the over-lapping sequence of the said 3 signals; and
a third logic circuit for decoding the 3 signals from said set of 3 sensors of the second set of said North sensors to derive a constant detection signal from the over-lapping sequence of the said 3 signals.

26. An elevator selector system for use with an elevator system having an elevator car that is vertically displaceable in a hoistway and a controller for controlling the car's vertical movement, the selector system comprising:
a selector housing mounted to the elevator car;
a tape vertically mounted in the hoistway, wherein the tape has two opposing surfaces and the tape passes through the selector housing;
a plurality of magnetic sensors for sensing the presence and polarity of magnets, the sensors spatially distributed vertically within the selector housing; and
a plurality of magnets disposed on both opposing surfaces of the tape.

27. An elevator selector system for use with an elevator system having an elevator car operating in a hoistway and a controller for controlling the car, the selector system comprising:
a tape mounted to the hoistway, the tape having two opposing surfaces, each of the two opposing surfaces having two tracks;
a selector housing mounted to the car, the selector housing having a plurality of openings through which the tape passes;
one or more magnetic signalers disposed on the tape, each of the magnetic signalers generating one or more signals, each of the signals indicating a member selected from the group consisting of directional limit top, directional limit bottom, normal terminal slow down top, normal terminal slow down bottom, emergency terminal speed limiting one, and emergency speed limiting two;
one or more magnetic sensors mounted in the selector housing for detecting the signals;
a logic circuit connected to the sensors and mounted in the selector housing for decoding the signals; and,
a wiring harness for connecting the logic circuit in the selector housing to the elevator controller.

28. The selector system of claim 27, wherein the magnetic signalers comprise polarized strip magnets.

29. The selector system of claim 28, wherein the magnetic sensors comprise hall effect sensors.

30. The selector system of claim 29, further comprising a circuit board having a plurality of holes and the hall effect sensors mounted in the plurality of holes.

31. The selector system of any one of claims 27-30, wherein
signals indicating directional limit top and directional limit bottom are generated by magnetic signalers disposed of on the first of the two tracks on the first surface of the tape; and,
signals indicating normal terminal slow down top, normal terminal slow down bottom, emergency terminal speed limiting one and emergency terminal speed limiting two are generated by magnetic signalers disposed of the second of the two tracks on the first surface of the tape.

32. The selector system of claim 27, wherein:
a first magnetic signaler indicating directional limit bottom is disposed on the first track on the first surface of the tape and vertically positioned at the bottom of the hoistway;
a second magnetic signaler indicating normal terminal slow down bottom is disposed on the second track on the first surface of the tape and vertically positioned near the bottom of the hoistway and above the bottom of the first magnetic signaler;
a third magnetic signaler indicating directional limit top is disposed on the first track of the first surface of the tape and vertically positioned at the top of the hoistway; and,
a plurality of magnetic signalers indicating normal terminal slow down top, emergency terminal speed limiting one and emergency terminal speed limiting two are disposed on the second track on the first surface of the tape and vertically positioned near the top of the hoistway and below the top of the third magnetic signaler, the plurality of magnetic signalers being polarized and arranged with alternating polarity such that each of the plurality of magnetic signalers has the opposite polarity from any of the other magnetic signalers positioned above or below it near the top of the hoistway on the second track.

33. The selector system of claim 27 or 32, further comprising:
a first and second light emitting device mounted in the selector housing, the first light emitting device located vertically above the second light emitting device; and,
a first and second light sensor, the first light sensor mounted in the selector housing horizontally in line with the first light emitting device, the second light sensor mounted in the selector housing horizontally in line with the second light emitting device.

34. An elevator selector system having a plurality of selector components adapted to prevent loss of the plurality of selector components during installation or maintenance, the elevator selector system comprising:
a selector housing mounted to the elevator car; and,
a plurality of tethers, each tether having one end connected to the selector housing and the other end connected to one of the plurality of selector components.

35. An alignment apparatus for use in installing an elevator selector system adapted for disposing of a plurality of magnetic signalers on a tape having an edge, the alignment apparatus comprising:
a body member;
a first side of the body member being adapted for handling; and,
a second side of the body member having a straight edge and a crevice, the depth of the crevice being equal to the functional horizontal distance of the magnetic signaler from the edge of the tape.

36. A method of disposing of a magnetic signaler on a tape having an edge for use in installing an elevator selector system, the method comprising:
placing the apparatus of claim 35 along the edge of the tape such that the tape fits inside the crevice; and,
moving the magnetic signaler along the tape horizontally until the magnetic signaler is aligned against the straight edge of the apparatus of claim 35.

37. The selector system of claim 27, the selector system further comprising tape guides for maintaining precise positioning of the tape in relation to the selector housing.

38. The selector system of claim 6, the selector system further comprising one or more of the following:
a selector leveling means;
a door zone identification means;
a floor identification means; and
a tape hole counting means.

39. An elevator selector system for use with an elevator system having an elevator car operating in a hoistway and a controller for controlling the car, the selector system comprising:
a tape mounted to the hoistway, the tape having two opposing surfaces;
a selector housing mounted to the car, the selector housing having a plurality of openings through which the tape passes;
a normal terminal slow down bottom means;
a normal terminal slow down top means;
an emergency terminal speed limiting one means;
an emergency terminal speed limiting two means;
directional limit top means;
a directional limit bottom means;
a selector leveling means;
a door zone identification means;
a floor identification means;
a tape hole counting means; and,
a wiring harness for connecting components in the selector housing to the elevator controller.

40. The selector system of claim 27, the selector system further comprising one or more magnetic signalers generating one or more signals selected from the group consisting of floor identification signals, level up, level down, door zone 1 and door zone 2.

41. The elevator selector system of claim 39 or 40 wherein the magnetic signalers are disposed of on both of the two opposing surfaces of the tape.

42. The elevator selector system of claim 27 wherein the magnetic signalers signaling normal terminal slow down top, normal terminal slow down bottom, emergency terminal speed limiting one and emergency speed limiting two are disposed of on one of the two tracks on one of the two opposing surface of the tape.

43. An elevator selector housing for use with an elevator selector system having an elevator car operating in a hoistway and a controller for controlling the car, the selector housing comprising:
plurality of openings through which the tape passes;
one or more magnetic sensors mounted in the selector housing, the magnetic sensors detecting a plurality signals comprising normal terminal slow down top, normal terminal slow down bottom, emergency terminal speed limiting one and emergency speed limiting two;
a logic circuit connected to the sensors and mounted in the selector housing for decoding the signals; and,
a wiring harness for connecting the logic circuit in the selector housing to the elevator controller.

44. The selector housing of claim 43 wherein the magnetic sensors detect the normal terminal slow down top, the emergency terminal speed limiting one, and the emergency terminal speed limiting two signals at the same vertical location in the hoistway.

45. The selector housing of claim 43 or 44 wherein the logic circuit comprises logic to decode a plurality of patterns detected by the magnetic sensors to differentiate between the plurality of signals.
